(19) United States
(12) Patent Application Publication
(10) Pub. No.: US 2010/0156941 A1
(43) Pub. Date: Jun. 24, 2010

(54) PHOTOGRAPHING METHOD USING MULTI-INPUT SCHEME THROUGH TOUCH AND KEY MANIPULATION AND PHOTOGRAPHING APPARATUS USING THE SAME

(75) Inventor: Jung-ah SEUNG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/621,646

(22) Filed: Nov. 19, 2009

(30) Foreign Application Priority Data
Dec. 19, 2008 (KR) 2008-130576

(51) Int. Cl. G09G 5/00; H04N 5/222; G09G 1/10

(52) U.S. Cl. 345/660; 348/333.01; 345/17; 348/E05.022

(57) ABSTRACT

A photographing method using a multi-input scheme through touch and key manipulation includes receiving a touch and a key manipulation from a user and changing a display status of an touched area according to the key manipulation. Accordingly, a complex function is performed by simply manipulation while maintaining existing button usability.

### CROSS-REFERENCE TO RELATED APPLICATIONS

This application claims priority under 35 U.S.C. §119 (a) from Korean Patent Application No. 10-2008-130576, filed on Dec. 19, 2008, in the Korean Intellectual Property Office, the disclosure of which is incorporated herein by reference in its entirety.

### BACKGROUND

1. Field of the Invention

The present general inventive concept relates to an input method to control the operation of a mobile apparatus which is held with both hands, and more particularly, to an apparatus which contains a function of photographing an image, such as a camcorder, a camera, and a camera mobile phone.

2. Description of the Related Art

Most image photographing apparatuses currently coming into the market may display an object to be photographed on a liquid crystal display (LCD). The image photographing apparatus may also have a user input function using a graphic to improve convenience of user's manipulation and to provide intuitive input. The user input function using the graphic may display a current state of the apparatus through a display apparatus, and may enable a user to input the user's intention by manipulating a key or touching a surface of the display apparatus and to manipulate the apparatus according to the user's intention.

Such an apparatus which enables the user to input his/her intention by touching the display surface is referred to as a touch screen. The touch screen may be a capacitive touch screen, a resistive touch screen, or an ultrasonic wave touch screen. The capacitive touch screen has opposing glass surfaces coated with a transparent special conductive metal and applies voltage to the corners of a display to generate high frequency. The capacitive touch screen senses a touch point by analyzing a high frequency waveform which is changed when a touch on the display is input. The resistive touch screen has a glass plate or a transparent plate coated with resistive material and a resistance value changes when a touch is input. The resistive touch screen senses a touch point based on the degree of voltage variation. The ultrasonic wave touch screen has a transmitter to emit a sound wave, a reflector to reflect the sound wave, and a receiver to receive the sound wave, all of which are attached to a display surface. The ultrasonic wave touch screen senses a touch point by sensing the advancing path of the sound wave.

Touch screens may have multi-touch functions of being aware of a plurality of inputs and may be applied to many products.

However, when a user holds a mobile apparatus with both hands, it is not easy for the user to perform the multi-touch functions with his/her both hands and the user is likely to drop the apparatus.

### SUMMARY

Example embodiments of the present general inventive concept provide a photographing apparatus which performs a complex function with a simplified manipulation using a multi-input through a touch on a touch screen and a physical key, and a method thereof.

Additional embodiments of the present general inventive concept will be set forth in part in the description which follows and, in part, will be obvious from the description, or may be learned by practice of the general inventive concept.

Features and/or utilities of the present general inventive concept may be achieved by a method of photographing a still image or a motion image, the method including displaying a still image or a motion image to be photographed on a touch screen, receiving a touch from a user on a portion to be photographed on the touch screen, zooming-in or zooming-out if there is a key manipulation of the user, and photographing within the zoomed-in or zoomed-out range. The zooming-in or zooming out may be performed with respect to a portion touched by the user.

The method may further include displaying a state which is zoomed-in or zoomed-out by touching the touch screen.

The zooming-in or zooming-out may be performed if a touch on the touch screen and a key manipulation are input simultaneously or in sequence.

When the zooming-in or zooming-out is performed by touching the touch screen, a range to be displayed on the touch screen may be displayed in advance.

The range to be displayed on the touch screen may be of a circular shape or a rectangular shape.

The range to be displayed on the touch screen may be displayed according to an aspect ratio of the touch screen or a photographing ratio.

The zooming-in or zooming-out may be performed using a digital zoom.

The method may further include adjusting a photographing angle of a lens to perform the zooming-in or zooming-out.

The operations may be performed in a standby mode or a photographing mode.

Features and/or utilities of the present general inventive concept may be also achieved by providing a method of photographing a still image or a motion image, the method including displaying a still image or a motion image to be photographed on a touch screen, receiving a touch from a user on the touch screen, determining a duration of the touch, displaying a different control screen according to the duration of the touch, and if focus adjusting is selected on the control screen by the user, performing focus-in or focus-out according to a manipulation of an external button.

The method may further include determining which area is touched, and performing focus-in or focus-out with respect to the touched area.

Features and/or utilities of the present general inventive concept may be also achieved by a method of photographing a still image or a motion image, the method including displaying a still image or a motion image to be photographed on a touch screen, receiving a touch from a user on the touch screen, determining a duration of the touch, displaying a different control screen according to the duration of the touch, and performing a controlling operation selected according to a selection made by the user on the control screen. If the duration of the touch on the touch screen is short, the control screen displays a control screen to control zooming-in or zooming-out, and if the duration of the touch is long, the control screen displays a control screen to control one of focus-in or focus-out, white balance, exposure control and LCD control.

Features and/or utilities of the present general inventive concept may be also achieved by a photographing apparatus including a photographing unit to photograph a target object, a touch screen to display a still image or a motion image to be photographed by the photographing unit, a key input unit to input a zoom-in or zoom-out command, and a controller to perform zooming-in or zooming-out and to photograph within a zoomed-in or zoomed-out range if a portion to be photographed is touched on the touch screen by the user and a key manipulation of the user is input through the key input unit. The zooming-in or the zooming-out is performed with respect to the portion touched by the user.

Features and/or utilities of the present general inventive concept may be also achieved by a photographing apparatus including a photographing unit to photograph a target object, a touch screen to display a still image or a motion image photographed by the photographing unit, a key input unit, and a controller to determine a duration of a touch and display a different control screen according to the duration of the touch if a portion to be photographed is touched on the touch screen by a user, and to perform focus-in or focus-out which is input by a key manipulation through the key input unit if the focus-in or focus-out is selected on the control screen by the user.

Features and/or utilities of the present general inventive concept may be also achieved by a photographing apparatus including a photographing unit to photograph a target object, a touch screen to display a still image or motion image photographed by the photographing unit, and a controller to determine a duration of a touch and display a different control screen on the touch screen according to the duration of the touch if a portion to be photographed is touched on the touch screen by the user, and to perform controlling operation which is selected according to a selection made on the control screen displayed on the touch screen by the user. The control screen displays a control screen to control zooming-in or zooming-out if the duration of the touch on the touch screen is short, and displays a control screen to control one of focus-in or focus-out, white balance, exposure control, and LCD control if the duration of the touch is long.

Features and/or utilities of the present general inventive concept may be also achieved by a photographing method including receiving a touch and a key manipulation from a user, and changing a display status of an area where the touch is input by the user according to the key manipulation.

Features and/or utilities of the present general inventive concept may be also achieved by a photographing method including receiving a touch and a key manipulation from a user, displaying a menu if a duration of the touch is longer than a predetermined time, and changing a display status of an area where the touch is input according to a selection set by the user using the menu.

Features and/or utilities of the present general inventive concept may also be realized by a method of capturing an image, the method including displaying an image-to-be-captured on a touch-receptive display, receiving a user touch on the display, and adjusting the image-to-be-captured based on the user touch.

The method may further include capturing the adjusted image-to-be-captured with a still-frame photograph or a video recording.

Adjusting the image-to-be-captured may include at least one of zooming into or zooming out of an area of the image-to-be-captured corresponding to the user touch.

Adjusting the image-to-be-captured may include at least one of focus-in, focus-out, white balance, exposure control, and LCD control.

The image-to-be-captured may be adjusted only in a portion of the image corresponding to an area touched by the user.

The method may further include displaying the adjusted image-to-be-captured on the touch-receptive display.

The method may further include detecting an input from a user from outside the touch-receptive display.

The method may further include determining a type of adjustment of the image-to-be-captured based on the user touch on the touch-receptive display and determining a magnitude of adjustment of the image-to-be-captured based on the detected input from the user from outside the touch-receptive display.

Detecting the input from the user from outside the touch-receptive display may include detecting whether the input from the user is simultaneous with the user touch on the touch-receptive display.

Detecting the input from the user from outside the touch-receptive display may include detecting whether the input from the user occurs within a predetermined period of time as the user touch on the touch-receptive display.

The method may further include determining a type of user touch on the touch-receptive display and determining a type of adjustment to the image-to-be-displayed based on the type of user touch on the touch-receptive display.

The type of user touch may be one of a short-duration touch, a long-duration touch, a touch-and-drag, a two-finger simultaneous touch, a two-finger simultaneous touch and drag, and a plurality of short-duration touches in succession.

When it is determined that the user touch is a two-finger simultaneous touch, adjustment of the image-to-be-captured may include zooming into an area defined by the two fingers touching the touch-receptive display.

When it is determined that the user touch is a two-finger simultaneous touch-and-drag, adjustment of the image-to-be-captured may include zooming into an area defined by the two fingers touching the touch-receptive display by a magnitude defined by a distance at least one of the fingers is dragged across the touch-receptive display.

Features and/or utilities of the present general inventive concept may also be realized by an image-capture apparatus including a touch-receptive display to display an image-to-be-captured and to receive a user touch, and a controller to adjust the image-to-be-captured based on the user touch.

The controller may be capable of capturing at least one of a still-frame photograph and a video recording.

The controller may adjust the image-to-be-captured by at least one of zooming into or zooming out of an area of the image-to-be-captured corresponding to the user touch.

The touch-receptive display may display the adjusted image-to-be-captured.

The image-capture apparatus may further include an input device outside the touch-receptive display to receive an input from a user.

The controller may determine a type of adjustment of the image-to-be-captured based on the user touch on the touch-receptive display, and the controller may determine a magnitude of adjustment of the image-to-be-captured based on the an input from the user from the input device outside the touch-receptive display.

The controller may determine a magnitude of adjustment of the image-to-be-captured based on the input from the input device outside the touch-receptive display only when the controller determines that the input from the input device is simultaneous with the user touch on the touch-receptive display.

The controller may determine a magnitude of adjustment of the image-to-be-captured based on the input from the input device outside the touch-receptive display only when the controller determines that the input from the input device occurs within a predetermined period of time as the user touch on the touch-receptive display.

The controller may determine a type of user touch on the touch-receptive display and may determine a type of adjustment to the image-to-be-displayed based on the type of user touch on the touch-receptive display.

The type of user touch may be one of a short-duration touch, a long-duration touch, a touch-and-drag, a two-finger simultaneous touch, a two-finger simultaneous touch and drag, and a plurality of short-duration touches in succession.

The image-capture apparatus may further include an image capture unit to convert received light corresponding to the image-to-be-captured into electrical signals and memory to store the electrical signals.

The image-capture apparatus may further include a signal processor to process the electrical signals from the image capture unit and a codec unit to compress the processed electrical signals from the signal processor and to transmit the compressed processed electrical signals to the memory.

The touch-receptive display may be an LCD screen.

Features and/or utilities of the present general inventive concept may also be realized by a computer-readable medium having code stored thereon, which, when executed, causes the computer to perform a method, the method including displaying an image-to-be-captured on a touch-receptive display, receiving a user touch on the display, and adjusting the image-to-be-captured based on the user touch.

The computer-readable medium may be one of a flash drive, CD, DVD, memory disk, memory chip, or memory card connectable to an image-capture apparatus.

As described above, according to the example embodiments of the present general inventive concept, a user command may be input by integrating a touch manipulation through a display and a physical key manipulation, so that a more simple process can be replaced for the complicated input process of several steps.

Also, even if a display is inclined to one side as in a camcorder, the multi-input scheme can be stably maintained and performed.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIGS. 1A, 1B, and 2 are views provided to explain zooming-in operation using a touch screen and a key, a range in which the zooming-in operation is performed, and a method thereof according to an exemplary embodiment of the present general inventive concept;

FIGS. 3A-3D illustrate results which are displayed on a touch screen in each step when the zooming-in operation is performed using a touch screen and a key according to an exemplary embodiment of the present general inventive concept;

FIGS. 4A-4F illustrate a process of displaying a menu to control a corresponding area and selecting an item “Focus” if a long touch is input on a touch screen according to an exemplary embodiment of the present general inventive concept;

FIG. 5 is a flowchart illustrating a process of photographing a still image by performing zooming-in or zooming-out according to an exemplary embodiment of the present general inventive concept;

FIG. 6 is a flowchart illustrating a process of photographing a motion image by performing zooming-in or zooming-out;

FIG. 7 is a flowchart illustrating a control process if a long touch is input on a touch screen when a still image is photographed;

FIG. 8 is a flowchart illustrating a control process if a long touch is input on the screen when a motion image is photographed;

FIG. 9 is a block diagram illustrating a photographing apparatus according to an exemplary embodiment of the present general inventive concept;

FIG. 10 illustrates a photographing unit, or an image-capture-unit; and

FIG. 11 illustrates a photographic device connected to an adjustable mount.

### DETAILED DESCRIPTION OF THE EMBODIMENTS

Reference will now be made in detail to embodiments of the present general inventive concept, examples of which are illustrated in the accompanying drawings, wherein like reference numerals refer to like elements throughout. The embodiments are described below to explain the present general inventive concept by referring to the figures.

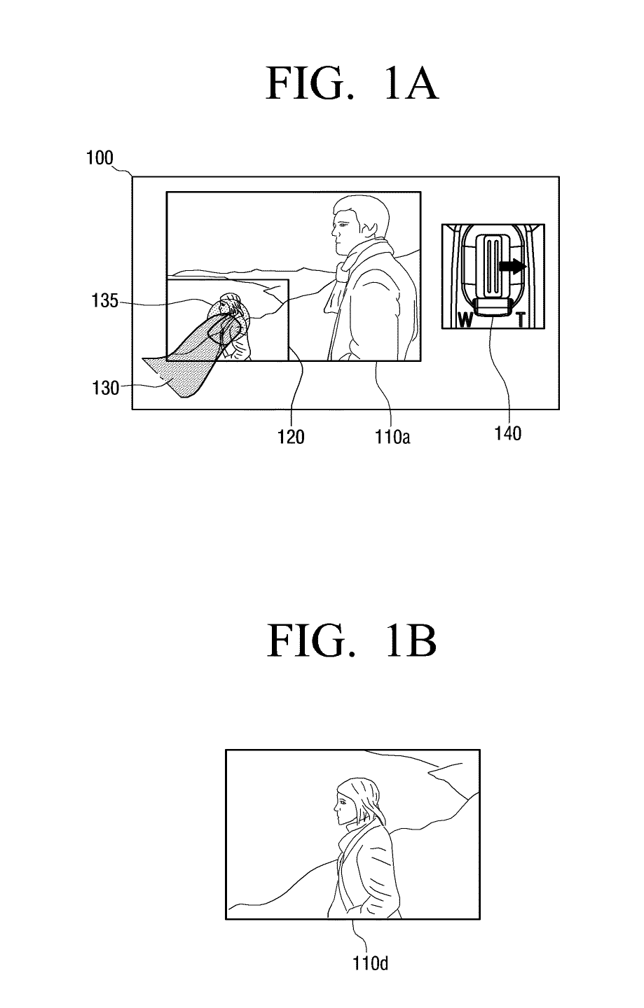

According to an embodiment of the present general inventive concept shown in FIG. 1A, a photographic device 100, or an image-capture apparatus, may include a touch screen 110a and a zoom key 140. The touch screen 110a may display an image-to-be photographed or captured. If a user 130 touches a desired portion 135 on a touch screen 110a, a guide 120 indicating a range to be zoomed-in is displayed around the touched portion 135. The guide 120 indicates a range of a still image or a motion image to be photographed, so that the user can photograph a desired range of the still image or the motion image by manipulating a zoom key 140.

The zoom key 140 may include a zoom-out portion “W” and a zoom-in portion “T,” and a user may change the dimensions of the guide 120 by manipulating the zoom key 140. As illustrated in FIG. 1B, once a user 130 has selected an area to be zoomed-in using the guide 120, the touch screen 110d may display the new image to be photographed or captured according to the user controls. In FIGS. 1A and 1B, reference numerals 110a and 110d both refer to a same touch screen (i.e. 110) displaying different images.

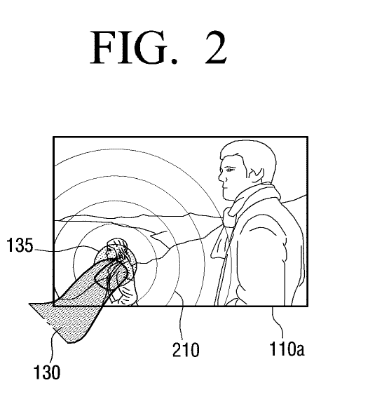

Although the guide of FIG. 1 is of a rectangular shape, this is merely an example. The guide may be displayed in the shape of circle or oval or any other shape. In FIG. 2, a guide 210 of a concentric circle shape is illustrated. The guide 120, 210 may be adjusted according to an aspect ratio of a still image or a motion image to be displayed, an aspect ratio of a still image or a motion image to be photographed, and an aspect ratio of a touch screen, and its shape may be changed.

To perform a zooming-in operation according to the displayed guide 120, 210, the user manipulates the zoom key 140 and obtains a zoomed-in image with a desired size. If the manipulation of the zoom-key 140 occurs, the photographing apparatus zooms-in on the touched portion 135 within a selected range using the digital zoom.

If the photographing apparatus employs a lens capable of adjusting an angle, it may perform the zooming-in operation by adjusting the angle of the lens using the optical zoom. If the photographing apparatus is mounted on a mount which is capable of moving vertically and horizontally, the photographing apparatus may perform the zooming-in operation by moving the mount vertically and horizontally and using the zoom-in function of the lens.

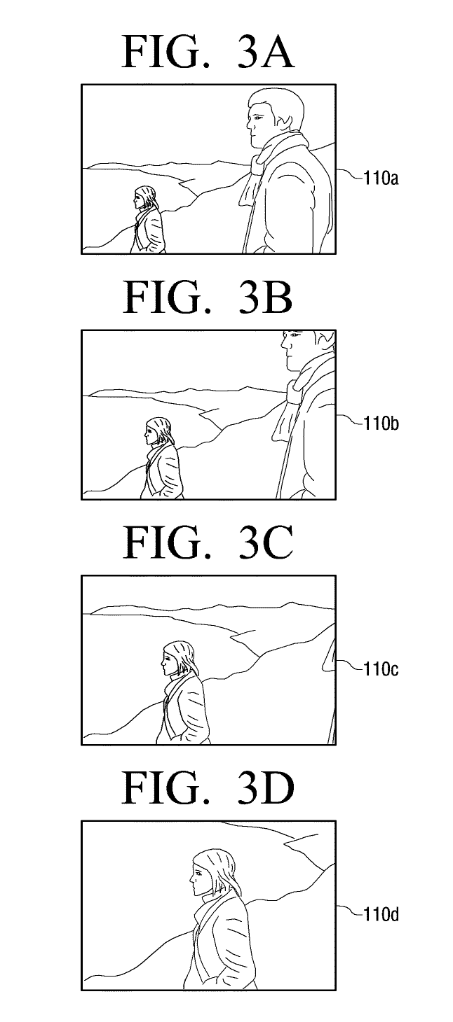

FIGS. 3A-3D illustrate results of a still image or a motion image which are displayed according to the guided range if the user performs the zooming-in operation as shown in FIGS. 1A and 1B. In FIGS. 3A-3D, as an image is progressively zoomed-in, the range of the image becomes narrower. In other words, FIG. 3A illustrates the touch screen 110a displaying an image-to-be-captured before zooming. FIGS. 3B and 3C illustrate the touch screen 110b, 110c after a user 130 has caused the image-capture device 100 to zoom-in on the selected portion 135 of the image. FIG. 3D illustrates the display on the touch screen 110d upon completion of the zoom-in process.

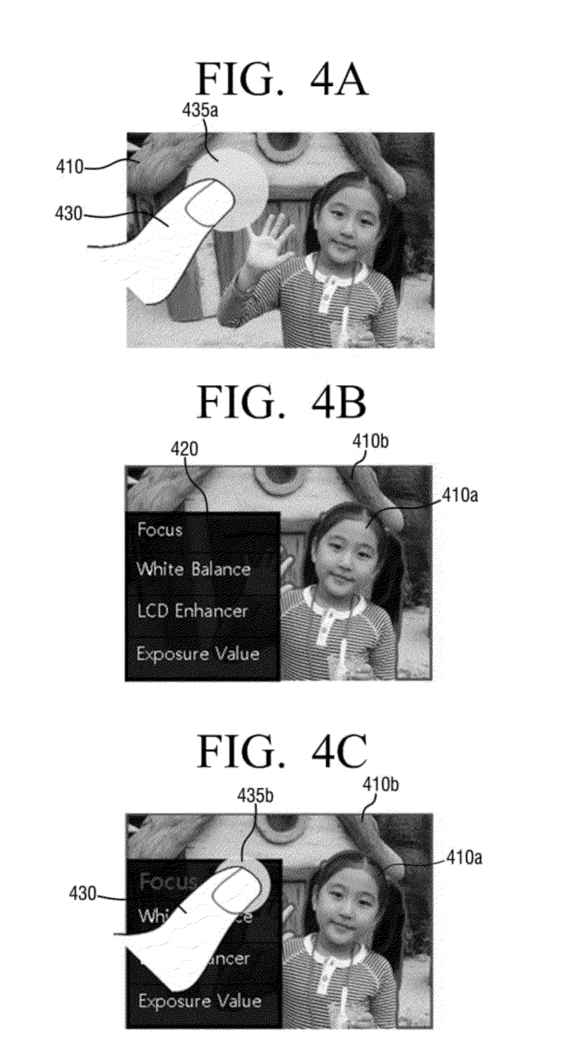

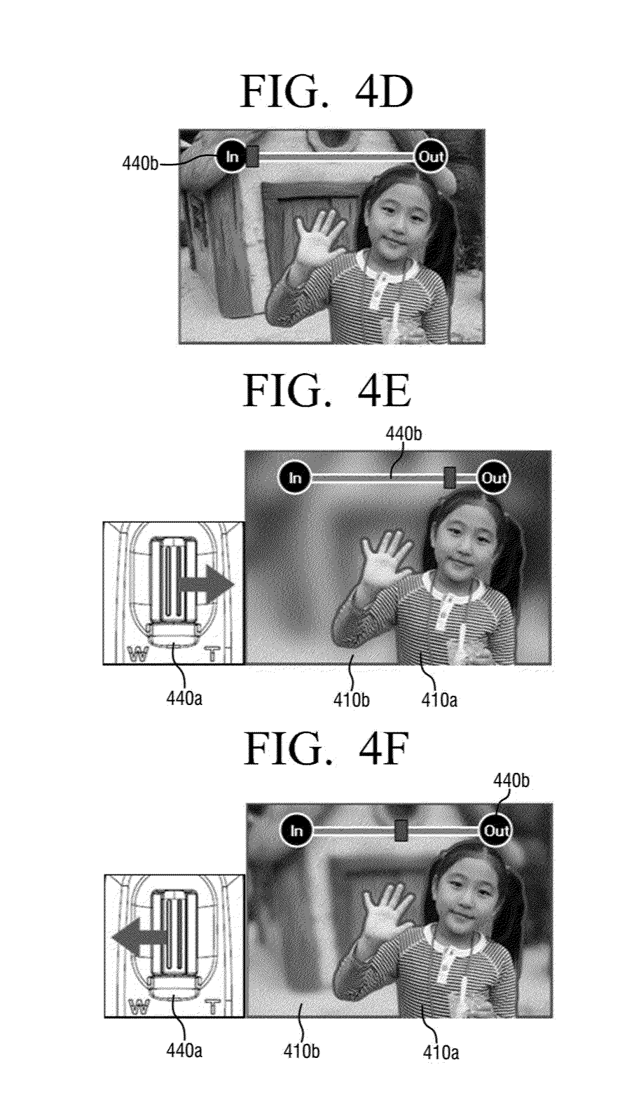

FIGS. 4A-4F illustrate a menu 420 to control variables to change the properties or characteristics of a touched image. The menu 420 may be displayed, for example, when a long touch is input on a touch screen 410.

In FIG. 4A, a user 430 selects a selection area 435a within a portion 410b of the touch screen 410 corresponding to a background. In response to the user 430 touch, the menu 420 is displayed, indicating various operations that may be performed on the portion 410b, as illustrated in FIG. 4B. For example, the menu 420 may appear in response to a particular type of touch by the user 430, such as a long touch, a short touch, or a plurality of touches simultaneously or in succession.

FIG. 4C illustrates a user 430 touching an area 435b corresponding to the “Focus” operation from the menu 420. As illustrated in FIG. 4D, a control bar 440b showing the focus level (focus-in and focus-out) is displayed on the upper part and the focus on the touched portion 410b is controlled by manipulating the zoom key 440a in the same way as when the zooming-in or zooming-out is performed.

Alternatively, a user 430 may touch an area on the touch screen 410 corresponding to the control bar 440b to control the focus of the selected area 410b. In other words, a user 430 may adjust characteristics in the selected area 410b by adjusting either the control bar 440b or the zoom key 440a.

The items “White Balance”, “LCD Enhancer”, and “Exposure Value” on the menu are controlled in the same way, and any menu to adjust property values of a still image or a motion image besides the above-described menu can be provided in the same way.

As illustrated in FIG. 4E, adjusting the zoom key 440a in a first direction toward reference letter “T” causes the selected area 410b to lose focus, while the non-selected area 410a, in this case corresponding to the foreground, remains in focus. As illustrated in FIG. 4F, adjusting the zoom key 440b in a second direction toward reference letter “W” causes the selected area 410b to re-focus. The level of focus may be displayed on the control bar 440b.

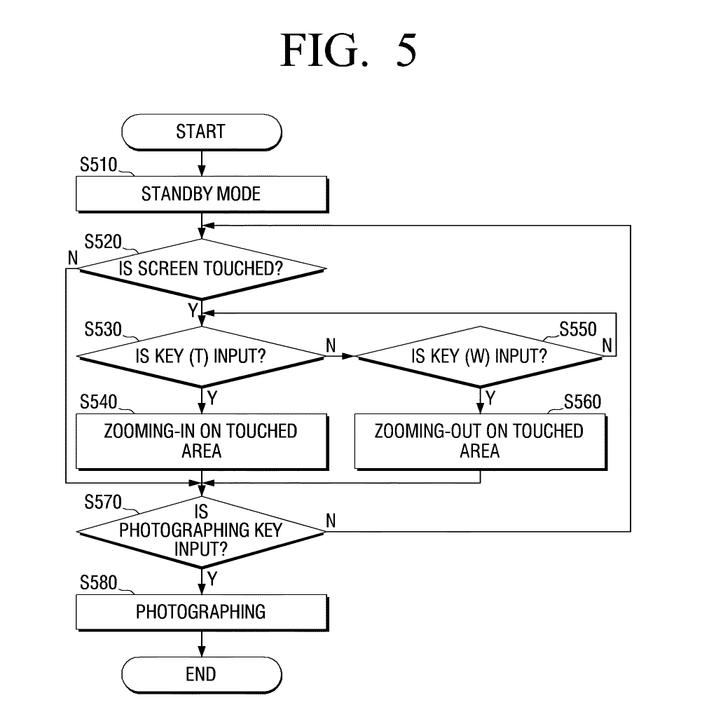

FIG. 5 is a flowchart illustrating a process of photographing a still image according to an exemplary embodiment of the present general inventive concept. Briefly, it is determined whether or not a touch is input on the touch screen, and, if the touch is input, zooming-in or zooming-out operation is performed according to an external manipulation using the zoom-key. If a photographing key is input, a photographing operation is performed. A detailed description of the method will be provided below.

As illustrated in FIG. 5, in a standby mode (S510), the photographing apparatus determines whether the touch-screen has been touched in operation S520. If the user touches the touch screen in operation S520-Y and if the user also manipulates the zoom key in the direction of T in operation S530-Y, the photographing apparatus performs zooming-in operation with respect to the touched portion such that an idle screen is zoomed-in on the touch screen in operation S540.

On the other hand, if the user touches the touch screen in operation S520-Y and also manipulates the zoom key in the direction of W in operations S530-N and S550-Y, the photographing apparatus performs zooming-out operation with respect to the touched portion such that an idle screen is zoomed-out on the touch screen in operation S560.

It is also possible to display either the zoomed-in state or the zoomed-out state by touching the touch screen.

After that, if a user manipulates a photographing key to generate a photographing key input in operation S570-Y, the idle screen which is currently being displayed on the touch screen is photographed and stored as a still image in operation S580.

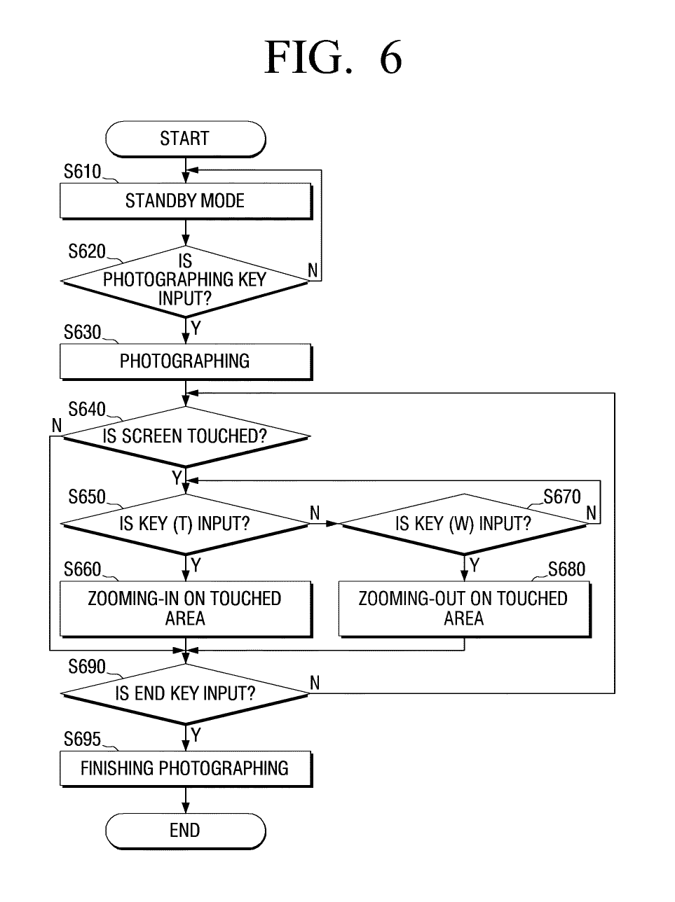

FIG. 6 is a flowchart illustrating a process of photographing a motion image according to an exemplary embodiment of the present general inventive concept. Briefly, the presence of a touch is determined when photographing operation is performed by inputting the photographing key, and zooming-in or zooming-out is performed when zoom-in or zoom-out is input through the zoom key, such that an image of a desired range is photographed and the photographing operation is finished through an end key. A more detailed description of the method will be provided below.

As shown in FIG. 6, in a standby mode (S610), if the photographing key is input by the user in operation S620-Y, a motion image is photographed in operation S630.

After that, if the user touches the touch screen in operation S640-Y and manipulates the zoom-key in the direction of T in operation S650-Y, the photographing apparatus performs zooming-in operation with respect to the touched portion such that an idle screen is zoomed in on the touch screen and is photographed as a motion image in operation S660.

On the other hand, if the user touches the touch screen in operation S640-Y and manipulates the zoom key in the direction of W in operation S670-Y, the photographing apparatus performs zooming-out with respect to the touched portion such that an idle screen is zoomed-out on the touch screen and is photographed as a motion image in operation S680.

After that, if the end key is input by the user in operation S690-Y, the photographing apparatus finishes photographing the motion image in operation S695.

In FIGS. 5 and 6, touching the screen and inputting the zoom-key may occur simultaneously or in sequence according to user's selection.

Also, in this embodiment, the touched portion is zoomed-in or zoomed-out by manipulating the zoom key, but this is merely an example. The technical idea of the present general inventive concept can be applied to the case in which a display status is changed according to a key manipulation with respect to a touched portion.

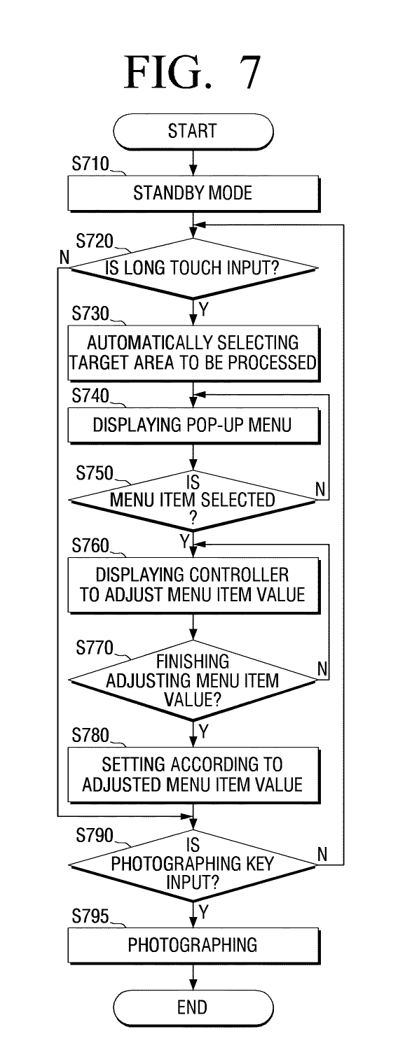

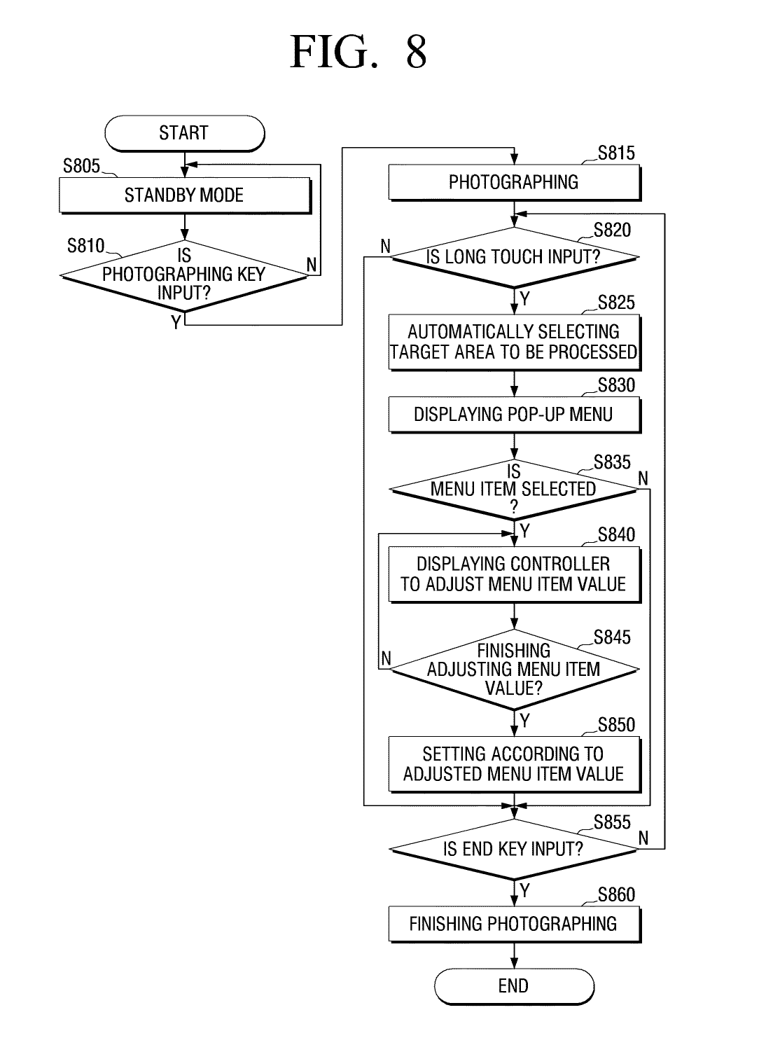

FIGS. 7 and 8 are flowcharts illustrating a controlling process if a long touch is input on a screen. FIG. 7 illustrates a controlling process if a long touch is input on a screen while a still image is photographed, and FIG. 8 illustrate a controlling process if a long touch is input on a screen while a motion image is photographed.

If a short touch is input and the zoom key is input, the zooming-in or zooming-out is performed according to the manipulation direction of the zoom key as shown in FIGS. 5 and 6. However, if a long touch is input, the photographing apparatus identifies which area is touched (object area or background area) and displays a control menu regarding the selected area so that the user can select a control variable to change. A detailed description of the method will be provided below.

The controlling process if a long touch is input on a screen while a still image is photographed will be described in detail with reference to FIG. 7.

As shown in FIG. 7, in a standby mode (S710), if the user inputs a long touch on the touch screen in operation S720-Y, the photographing apparatus automatically selects the touched area as a target area to be processed in operation S730.

More specifically, in operation S730, it is determined whether the touched area indicates an object or a background and the touched area is automatically selected as a target area. Specifically, 1) if the touched area indicates an object, an area including the object is selected as a target area to be processed, and 2) if the touched area indicates a background, an area including the background is selected as a target area to be processed. Referring to FIGS. 4A-4F, the background 410b is touched by the user 430 and the area including the background 410b is selected as a target area to be processed.

Next, the photographing apparatus displays a pop-up menu on the display of the touch screen in operation S740. The pop-up menu contains a list of menu items which are used to input a command to change a setting value regarding the selected area.

If one of the menu items contained in the pop-up menu is selected in operation S750-Y, the photographing apparatus displays a controller to adjust the setting value (menu item value) regarding the selected menu item on the display of the touch screen in operation S760.

The menu item is selected from the pop-up menu by user's touch on it in operation S750. Also, the user may adjust the menu item value using the controller displayed in operation S760.

If the menu item “Focus” is selected in operation S750, a control bar which is a controller indicating the focus level is displayed. Therefore, the user can photograph an image while adjusting the focus value using the zoom-key, which was described with reference to FIGS. 4A-4F.

If adjusting the menu item value is finished in operation S770-Y, the photographing apparatus sets the selected target area according to the adjusted menu item value in operation S780.

Next, if the photographing key is input by the user in operation S790-Y, an idle screen displayed on the touch screen at that time is photographed and is stored as a still image in operation S795.

Hereinafter, a controlling process if a long touch is input on the screen while a motion image is photographed will be described with reference to FIG. 8.

As shown in FIG. 8, in a standby mode (S805), if the user inputs the photographing key in operation S810-Y, a motion image is photographed in operation S815.

After that, if a long touch on the touch screen is input by the user in operation S820-Y, the photographing apparatus automatically selects the touched area as a target area to be processed in operation S825. Operation S825 is similar to operation S730 of FIG. 7 and thus detailed description thereof will be omitted.

Next, the photographing apparatus displays a pop-up menu on the display of the touch screen in operation S830. The pop-up menu contains a list of menu items which are used to input a command to change a setting value regarding the selected area.

If one of the menu items contained in the pop-up menu is selected in operation S835-Y, the photographing apparatus displays a controller to adjust a setting value (menu item value) regarding the selected menu item on the display of the touch screen in operation S840.

Selecting the menu item in operation S840 may be performed by user's touch on a desired menu item displayed on the touch screen. Also, the user may adjust the menu item value using the controller displayed in operation S840.

If adjusting the menu item is finished in operation S845-Y, the photographing apparatus sets the selected area according to the adjusted menu item value in operation S850.

Next, if an end key is input by the user in operation S855-Y, the photographing apparatus finishes photographing the motion image in operation S860.

If a long touch is input, it is possible to determine which area is selected and display a menu to change a photographing control variable regarding the selected area as described above. However, it is also possible to change a photographing control variable regarding the entire image to be photographed without determining which area is selected.

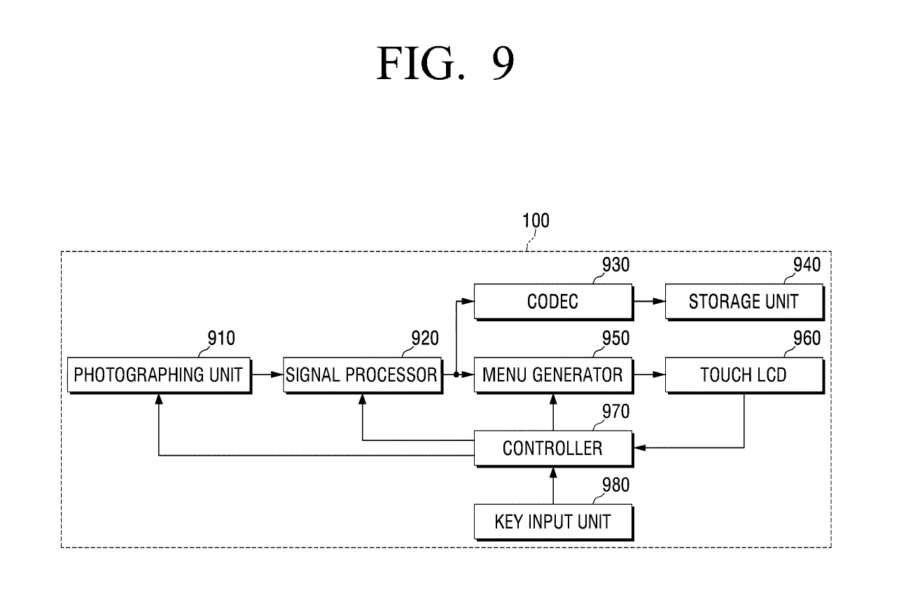

FIG. 9 is a block diagram illustrating a photographing apparatus 100 according to an exemplary embodiment of the present general inventive concept. As shown in FIG. 9, a photographing apparatus 100 includes a photographing unit 910, a signal processor 920, a CODEC 930, a storage unit 940, a menu generator 950, a touch LCD 960, a controller 970, and a key input unit 980.

The photographing unit 910 converts an image to be photographed, which is incident through a lens and is formed on an optical surface, into an image signal.

The signal processor 920 performs signal-processing with respect to the image signal generated by the photographing unit 910. Representative examples of the signal-processing performed by the signal processor 920 are digital zoom and auto white balance (AWB).

The CODEC 930 compresses the image signal signal-processed by the signal processor 920 and stores it to the storage unit 940, or decompresses the compressed image signal stored in the storage unit 940 and provides it to the menu generator 950.

The menu generator 950 generates a menu and adds the menu to the image. The image provided to the menu generator 950 may include at least one of 1) an image which has been photographed by the photographing unit 910 and signal-processed by the signal processor 920, and 2) an image which has been decompressed by the CODEC 930.

The touch LCD 960 displays the image to which the menu is added by the menu generator 950. If no menu is added by the menu generator 950, the touch LCD 960 displays only the image.

The touch LCD 960 may serve as a means of receiving a touch manipulation from the user.

The controller 970 controls the photographing unit 910, the signal processor 920, and the menu generator 950 according to the user's manipulation input through the touch LCD 960 and the key input unit 980. More specifically, the controller 970 performs the processes described with reference to FIGS. 5 to 8 and also controls the photographing unit 910, the signal processor 920, and the menu generator 950, if necessary.

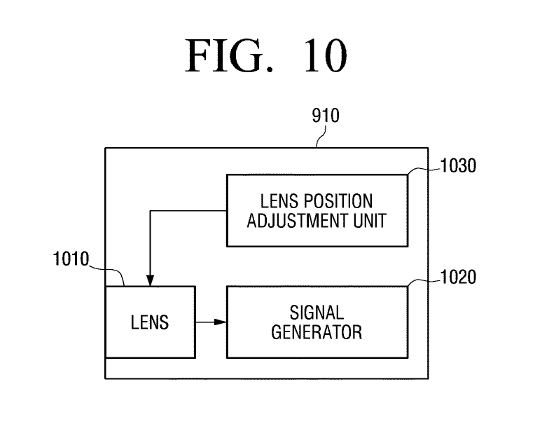

FIG. 10 illustrates a photographing unit 910, or an image capture unit, corresponding to the photographing unit of FIG. 9. The photographing unit 910 may include a lens, or lenses, 1010 to receive light corresponding to an image-to-be-captured and a signal generator 1020 to convert the light to electrical signals. The photographing unit 910 may further include a lens position adjustment unit 1030 to adjust the position of the lens 1010. For example, the lens position adjustment unit 1030 may be controlled based on a user selection to focus on one portion of an image-to-be-displayed, and may in turn control the position of the lens 1010.

The lens 1010 may be adjusted by a motor, a piezo-electric material, or any other device capable of changing a position or orientation of the lens 1010.

While the lens position adjustment unit 1030 may manipulate the lens 1010 based on a user input to adjust a characteristic of an image-to-be-captured, the characteristic of the image-to-be-captured may also be adjusted by the controller 970 and signal processor 920 of FIG. 9. For example, the controller 970 may cause the signal processor 920 to manipulate the electrical signals corresponding to the image-to-be-captured so that a portion of the image-to-be-captured is out of focus.

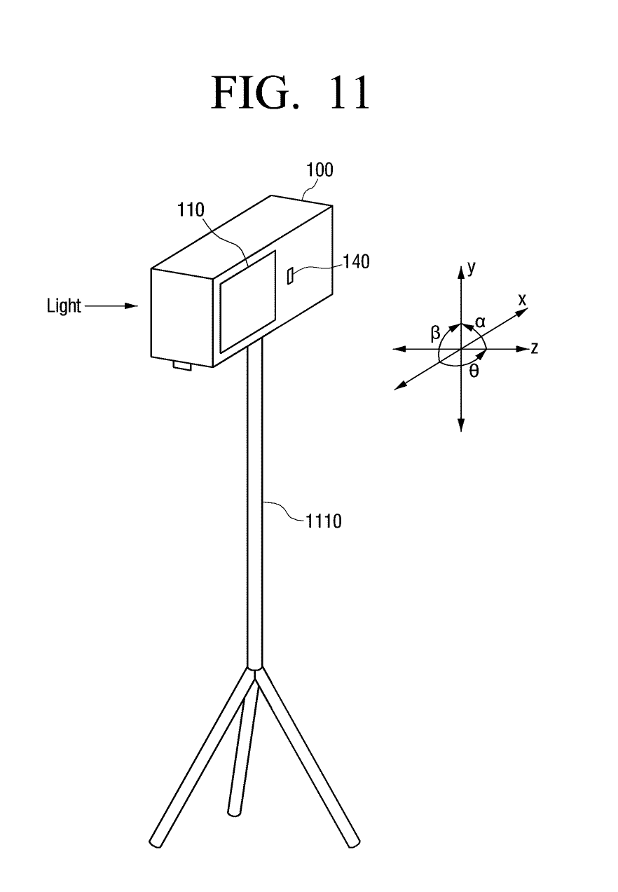

FIG. 11 illustrates a photographic device 100 connected to an adjustable mount 1110. Light from an image may enter the photographic device from a front side, and the image-to-be-captured may be displayed on a touch-screen, or touch-receptive display 110, on the same side or another side of the photographic device 100. The zoom key 140 may also be used to manipulate the image-to-be-captured.

The adjustable mount 1110 may receive signals from the photographic device 100 to move the adjustable mount in any of directions x, y, and z based on a user input. The mount may also rotate around any of the axes x, y, z in directions α, θ, and β, respectively. For example, if a user zooms in on a portion of the image-to-be-captured displayed in a lower corner of the display 110, the mount 1110 may physically move to better display the selected portion. The movement of the mount 1110 may be combined with movement of the lens 1010 of FIG. 10, or it may occur independently of the lens 1010.

The mount 1110 may be motorized so that upon receiving command signals from the photographic device 100, it can change the position and/or orientation of the photographic device 100 without direct intervention by a user.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit code through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A method of photographing at least one of a still image and a motion image, the method comprising:
displaying at least one of a still image and a motion image to be photographed on a touch screen;
receiving a touch from a user on the touch screen corresponding to a portion of the image to be photographed;
zooming-in or zooming-out if a key manipulation of the user is detected, the zoom-in or zoom-out corresponding to a portion of the image touched by the user; and
photographing within the zoomed-in or zoomed-out range.

2. The method as claimed in claim 1, further comprising:
displaying a one of a zoomed-in or zoomed-out image in response to a touch on the touch screen.

3. The method as claimed in claim 1, wherein the zooming-in or zooming-out is performed if a touch on the touch screen and a key manipulation are input either simultaneously or in sequence.

4. The method as claimed in claim 1, wherein an area to be zoomed-in or zoomed-out is displayed on the touch screen prior to zooming-in or zooming-out the image to be photographed.

5. The method as claimed in claim 4, wherein the area to be zoomed-in or zoomed-out on the touch screen is represented by a circular shape or a rectangular shape on the image to be photographed.

6. The method as claimed in claim 4, wherein a size of the area to be zoomed-in or zoomed-out on the touch screen is displayed according to an aspect ratio of the touch screen or a photographing ratio.

7. The method as claimed in claim 1, wherein the zooming-in or zooming-out is performed using a digital zoom.

8. The method as claimed in claim 1, further comprising adjusting a photographing angle of a lens to perform the zooming-in or zooming-out.

9. The method as claimed in claim 1, wherein the operations are performed in a standby mode or a photographing mode.

10. A method of photographing a still image or a motion image, the method comprising:
displaying a still image or a motion image to be photographed on a touch screen;
receiving a touch from a user on the touch screen;
determining a duration of the touch;
displaying a control screen according to the duration of the touch; and
if focus adjusting is selected on the control screen by the user, performing focus-in or focus-out by manipulating an external button.

11. The method as claimed in claim 10, further comprising;
determining an area that is touched; and
performing focus-in or focus-out with respect to the touched area.

12. A method of photographing a still image or a motion image, the method comprising:
displaying a still image or a motion image to be photographed on a touch screen;
receiving a touch from a user on the touch screen;
determining a duration of the touch;
displaying a control screen according to the duration of the touch; and
performing a controlling operation according to a selection made on the control screen by the user,
wherein, if the duration of the touch on the touch screen is short, the control screen displays a control screen to control zooming-in or zooming-out, and if the duration of the touch is long, the control screen displays a control screen to control one of focus-in or focus-out, white balance, exposure control, and LCD control.

13. A photographing apparatus, comprising:
a photographing unit to photograph a target object;
a touch screen to display a still image or a motion image to be photographed by the photographing unit;
a key input unit to input a zoom-in or zoom-out command; and
a controller to perform zooming-in or zooming-out and to photograph within a zoomed-in or zoomed-out range if a portion to be photographed is touched on the touch screen by the user and a key manipulation of the user is input via the key input unit,
wherein the zooming-in or the zooming-out is performed with respect to the portion touched by the user.

14. A photographing apparatus, comprising:
a photographing unit to photograph a target object;
a touch screen to display a still image or a motion image to be photographed by the photographing unit;
a key input unit;
a controller to determine a duration of a touch and to display a control screen according to the duration of the touch if a portion to be photographed is touched on the touch screen by a user, and to perform focus-in or focus-out which is input by a key manipulation through the key input unit if the focus-in or focus-out is selected on the control screen by the user.

15. A photographing apparatus, comprising:
a photographing unit to photograph a target object;
a touch screen to display a still image or motion image to be photographed by the photographing unit; and
a controller to determine a duration of a touch and to display a control screen on the touch screen according to the duration of the touch, and to perform a controlling operation according to a selection made by the user on the control screen,
wherein the control screen displays a control screen to control zooming-in or zooming-out if the duration of the touch on the touch screen is short, and displays a control screen to control one of focus-in or focus-out, white balance, exposure control, and LCD control if the duration of the touch is long.

16. A photographing method, comprising:
receiving a touch and a key manipulation from a user; and
changing a display status of an area where the touch is input by the user according to the key manipulation.

17. A photographing method, comprising;
receiving a touch and a key manipulation from a user;
displaying a menu if a duration of the touch is longer than a predetermined time; and
changing a display status of an area where the touch is input according to a selection set by the user using the menu.

18. A method of capturing an image, the method comprising:
displaying an image-to-be-captured on a touch-receptive display;
receiving a user touch on the display; and
adjusting the image-to-be-captured based on the user touch.

19. The method according to claim 18, further comprising:
capturing the adjusted image-to-be-captured with a still-frame photograph or a video recording.

20. The method according to claim 18, wherein adjusting the image-to-be-captured includes at least one of zooming into or zooming out of an area of the image-to-be-captured corresponding to the user touch.

21. The method according to claim 18, wherein adjusting the image-to-be-captured includes at least one of focus-in, focus-out, white balance, exposure control, and LCD control.

22. The method according to claim 21, wherein the image-to-be-captured is adjusted only in a portion of the image corresponding to an area touched by the user.

23. The method according to claim 18, further comprising:
displaying the adjusted image-to-be-captured on the touch-receptive display.

24. The method according to claim 18, further comprising:
detecting an input from a user from outside the touch-receptive display.

25. The method according to claim 24, further comprising:
determining a type of adjustment of the image-to-be-captured based on the user touch on the touch-receptive display; and
determining a magnitude of adjustment of the image-to-be-captured based on the detected input from the user from outside the touch-receptive display.

26. The method according to claim 24, wherein detecting the input from the user from outside the touch-receptive display includes detecting whether the input from the user is simultaneous with the user touch on the touch-receptive display.

27. The method according to claim 24, wherein detecting the input from the user from outside the touch-receptive display includes detecting whether the input from the user occurs within a predetermined period of time as the user touch on the touch-receptive display.

28. The method according to claim 18, further comprising:
determining a type of user touch on the touch-receptive display; and
determining a type of adjustment to the image-to-be-displayed based on the type of user touch on the touch-receptive display.

29. The method according to claim 28, wherein the type of user touch is one of a short-duration touch, a long-duration touch, a touch-and-drag, a two-finger simultaneous touch, a two-finger simultaneous touch and drag, and a plurality of short-duration touches in succession.

30. The method according to claim 29, wherein when it is determined that the user touch is a two-finger simultaneous touch, adjustment of the image-to-be-captured includes zooming into an area defined by the two fingers touching the touch-receptive display.

31. The method according to claim 29, wherein when it is determined that the user touch is a two-finger simultaneous touch-and-drag, adjustment of the image-to-be-captured includes zooming into an area defined by the two fingers touching the touch-receptive display by a magnitude defined by a distance at least one of the fingers is dragged across the touch-receptive display.

32. An image-capture apparatus, comprising:
a touch-receptive display to display an image-to-be-captured and to receive a user touch; and
a controller to adjust the image-to-be-captured based on the user touch.

33. The image-capture apparatus according to claim 32, wherein the controller is capable of capturing at least one of a still-frame photograph and a video recording.

34. The image-capture apparatus according to claim 32, wherein the controller adjusts the image-to-be-captured by at least one of zooming into or zooming out of an area of the image-to-be-captured corresponding to the user touch.

35. The image-capture apparatus according to claim 32, wherein the touch-receptive display displays the adjusted image-to-be-captured.

36. The image-capture apparatus according to claim 32, further comprising:
an input device outside the touch-receptive display to receive an input from a user.

37. The image-capture apparatus according to claim 36, wherein:
the controller determines a type of adjustment of the image-to-be-captured based on the user touch on the touch-receptive display; and
the controller determines a magnitude of adjustment of the image-to-be-captured based on the an input from the user from the input device outside the touch-receptive display.

38. The image-capture apparatus according to claim 37, wherein the controller determines a magnitude of adjustment of the image-to-be-captured based on the input from the input device outside the touch-receptive display only when the controller determines that the input from the input device is simultaneous with the user touch on the touch-receptive display.

39. The image-capture apparatus according to claim 37, wherein the controller determines a magnitude of adjustment of the image-to-be-captured based on the input from the input device outside the touch-receptive display only when the controller determines that the input from the input device occurs within a predetermined period of time as the user touch on the touch-receptive display.

40. The image-capture apparatus according to claim 32, wherein the controller determines a type of user touch on the touch-receptive display; and
determines a type of adjustment to the image-to-be-displayed based on the type of user touch on the touch-receptive display.

41. The image-capture apparatus according to claim 40, wherein the type of user touch is one of a short-duration touch, a long-duration touch, a touch-and-drag, a two-finger simultaneous touch, a two-finger simultaneous touch and drag, and a plurality of short-duration touches in succession.

42. The image-capture apparatus according to claim 32, further comprising:
an image capture unit to convert received light corresponding to the image-to-be-captured into electrical signals; and
memory to store the electrical signals.

43. The image-capture apparatus according to claim 42, further comprising:
a signal processor to process the electrical signals from the image capture unit; and
a CODEC unit to compress the processed electrical signals from the signal processor and to transmit the compressed processed electrical signals to the memory.

44. The image-capture apparatus according to claim 32, wherein the touch-receptive display is an LCD screen.

45. A computer-readable medium having code stored thereon, which, when executed, causes the computer to perform a method, the method comprising:
displaying an image-to-be-captured on a touch-receptive display;
receiving a user touch on the display; and
adjusting the image-to-be-captured based on the user touch.

46. The computer-readable medium according to claim 45, wherein the computer-readable medium is one of a flash drive, CD, DVD, memory disk, memory chip, or memory card connectable to an image-capture apparatus.
